(19) United States
(12) Patent Application Publication
(10) Pub. No.: US 2005/0069222 A1
(43) Pub. Date: Mar. 31, 2005

(54) Process and system for digital data signal processing

(76) Inventor: Marco Winzker, Konigswinter (DE)

Correspondence Address: WILLIAM COLLARD;COLLARD & ROE, P.C., 1077 NORTHERN BOULEVARD, ROSLYN, NY, 11576, US

(21) Appl. No.: 10/890,801

(22) Filed: Jul. 14, 2004

(30) Foreign Application Priority Data
Jul. 17, 2003 (DE) 103 32 734.7

(51) Int. Cl. G06K 9/40; G06K 9/36

(52) U.S. Cl. 382/275; 382/276

(57) ABSTRACT

In a process for signal data processing, in particular digital signal data processing, a first memory (M1) of comparatively large memory capacity for recording digital data of an original image is provided, whereby the original image comprises at least a first image part and a second image part and the first image part is defined by first input digital data, whereas the second image part is structured substantially homogeneously. A second memory (C1) of comparatively small memory capacity is also provided.

To modify at least one pixel of the original image in a further image (R) at least a part of the first input digital data from the first memory (M1) is transferred to the second memory and from the part of the first initial digital data stored in the second memory (C1) first initial digital data are calculated, from which the new image (R) is generated. To replace first digital data, not stored in the second memory (C1), data are generated according to at least one error concealment process. Precise information is used to generate the entire second image part in the new image (R).

The invention relates to a process and a system for digital data signal processing according to the preamble in claim 1 or 13.

An application of such digital processing with simultaneous transformation of coordinates is digital index correction of digital data. In recording and/or playback of digital data warping can occur through optic components, electronic components, by projection or other effects. Such instances of warping are unwanted, since they e.g. can complicate evaluation of digital data or are sensed by an observer as poor image quality.

For the purpose of correcting warping during recording of digital data digital data are equalised after recording. To correct warping during display of digital data, digital data are pre-warped prior to display, so that overlapping of pre-warping and warping during display is fully or partially offset. The correction of recording warping, pre-warping for display and the combination of both procedural steps is designated as index correction.

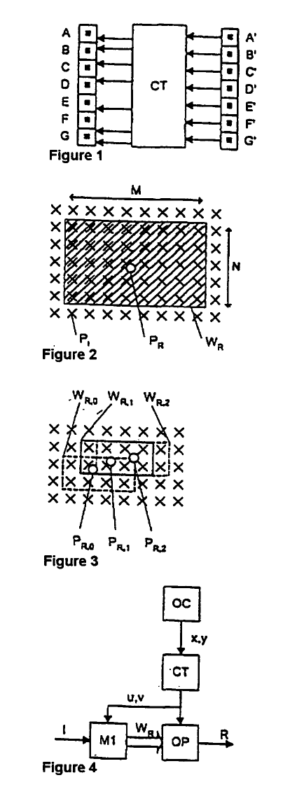

In Wolberg, ‘Digital Image Warping’, IEEE Computer Society Press, 1990 ‘inverse Mapping’ is described as a method for digital electronic index correction. The principal operating method is described in FIG. 1. The output values A′, B′, C′, . . . G′ are allocated corresponding input values A; B, C, . . . G by transformation of coordinates (CT). The case can arise where the output values are not directly assigned an input value, rather a position between input values corresponds to an output value.

The transformation of coordinates at the same time determines the index correction. To be able to correct different distortions with one system, it is necessary to be able to vary the transformation of coordinates within certain boundaries. Because the process described here is independent of implementing the transformation of coordinates no further details on this are given.

For calculating an output value whereof the position id between input values several input values must be observed in the environment of the calculated position. The case for digital data is shown in FIG. 2. An output value P_{R} is to be calculated from the input values P_{I}. For this the input data of the window W_{R} must be available with the height N and the width M. The values for M and N depend on the quality of the calculation of the output value. The greater M and N are, the better the calculation outcome can be and the greater the expenditure.

For index correction for each pixel of the image to be made the corresponding position in the input image must be calculated and the digital data of the corresponding window observed. FIG. 3 shows three output values P_{R,0}, P_{R,1}, and P_{R,2} and the corresponding windows W_{R,0}, W_{R,1}, and W_{R,2}. The values for M and N are modified relative to FIG. 2.

### STATE OF THE ART

Direct conversion of the process described is shown in FIG. 4. The input image I is stored in a memory M1. The output control OC now generates for each pixel of the output image R its coordinates x, y. These coordinates are transformed by transformation of coordinates CT into transformed coordinates u, v and forwarded to the memory M1 and output processing OP. The memory gives the window WR for each pixel to output processing, which calculates the output image R.

For each output image with this conversion M*N pixels must be read from the memory M1. This corresponds to a very high data rate, which leads to high expenditure. In FIG. 4 this is indicated by a broad arrow. Since for each output pixel M*N new pixels are read in, it must be considered that memory access can be highly irregular. Enabling such random access likewise requires very high expenditure.

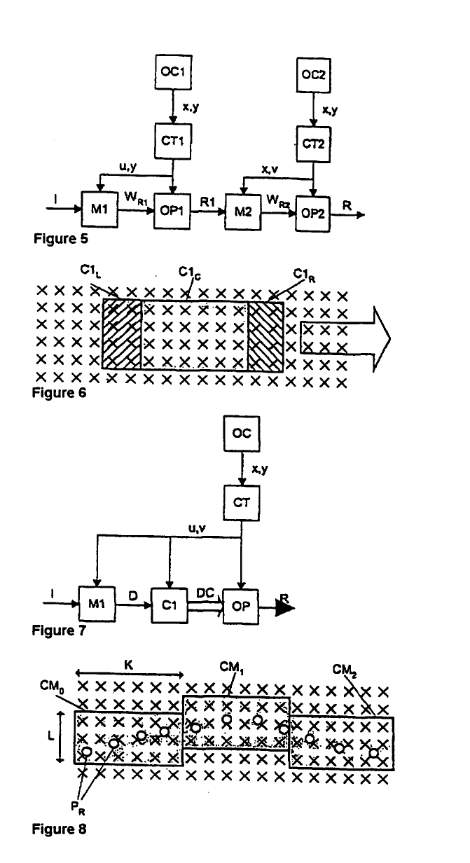

In Wolberg ‘Digital Image Warping’,” IEEE Computer Society Press, 1990 a process with reduced requirements for memory access is described. The two-dimensional index correction is split into two one-dimensional index corrections. FIG. 5 illustrates this process. The input image stored in memory M1 is first processed in one dimension, i.e. horizontal or vertical.

For this the output control OC1 for each pixel of an intermediate image R1 whereof the coordinates are x, y.

These coordinates are transformed from the transformation of coordinates CT1 in one dimension, whereas the other coordinate is taken over. The coordinates x, y are thus conveyed to the memory M1 and the first output processing OP1. Due to the one-dimensional processing the height N of the processing window W_{R1} is equal to 1. The intermediate image R1 is stored in a memory M2. The second dimension is processed with this intermediate image.

The output control OC2 generates for each pixel of the output image R its coordinates x, y. These coordinates are transformed by the transformation of coordinates CT2 in the not yet processed dimension. The coordinates x, y are sent to the memory M2 and the second output processing OP2 and the output image R is calculated. The height N of the processing window W_{R2} is equal to 1.

With this method the transmission bandwidth between memory and processing unit is reduced. Due to the temporal and divided processing the memory access is additionally very regular and thus expensive to implement. The additionally required memory M2 between first and second procedural step is disadvantageous. Also, either the memory M2 is to be configured with high word width and thus high memory requirement by splitting into two procedural steps, or a memory M2 with minimal word width leads to computing errors.

U.S. Pat. No. 3,986,171 describes a system, in which a small fast cache memory contains a copy of a part of the main memory. A memory controller decides whether access via the faster cache memory can be intercepted, or whether access must be made to the main memory. This process cannot be used however if processing is to proceed keeping pace with the task, i.e. in real time, since time is reduced to provide memory contents only in temporal means, though not in the unfavourable case.

In Volkers et. al, “Cache Memory Design For The Data Transport To Array Processors,” Proc. of IEEE Int. Symposium on Circuits and Systems, January 1990, pp. 49-52, a hierarchical memory system is expanded on to the extent that the contents of the cache memory comprise a rectangular area of the main memory. This is shown in FIG. 6. At the request of a controller the contents of the cache memory can be modified such that pixels from the left area of the memory CL₁ can no longer be stored and the releasing memory cells are loaded with input values C1_{R} to the right of the current content C1_{C} of the cache memory.

The cache thus corresponds to a window pushed over the input image.

An array for converting this process is shown in FIG. 7.

Output control OC and transformation of coordinates CT create transformed coordinates u,v. These are forwarded to the memory M1, which forwards data D to a cache memory C1.

The cache memory C1 sends data DC to the output processing OP, which calculates the output image R.

To use this process it must be ensured that only pixels from the current area C1_{C} (FIG. 6) of the cache memory are used for processing. For digital processing with simultaneous transformation of coordinates this process cannot be used, however, since there is no assurance that the necessary input signals originate from a horizontal area via the image.

In DE 100 52 263 A1 a hierarchical memory system is described, in which a cache memory comprises an area of the main memory, which is not necessarily rectangular. If data, which are to be accessed, are not in the cache memory, error concealment takes place. This process does not however consider the image edges.

### Problem

The object of the present invention is to provide a process and a system for digital signal data processing, whereby access to memory for the input image is given with minimal effort.

A processing window can be distinguished from the abovementioned processing window both in the horizontal and in the vertical position, as is shown in FIG. 3. The distance of successive processing windows is variable and depends on the selected transformation of coordinates and current position of the output values to be calculated.

This task is solved by the characteristics of claim 1.

The invention will now be described by means of the figures.

Data from a main memory are stored in a cache memory such that a non-horizontal image section can be stored and error concealment takes place with access to data, not found in the cache memory.

The part of the main memory (first memory), stored in the cache memory (second memory), is shown in FIG. 8. Data of the main memory are required in the vicinity of points PR.

The cache memory thus comprises segments of height L and width K, which superpose one another horizontally, but which can be distinguished in the vertical position. The width K of the segments can be selected such that through regular memory access to the main memory M1 minimal effort is needed. The vertical offset of adjacent segments should be less than L; this is however not absolutely necessary.

Likewise L should be greater than or equal to the height N of the processing window W_{R} (cf. FIG. 2); likewise, this is however not absolutely necessary.

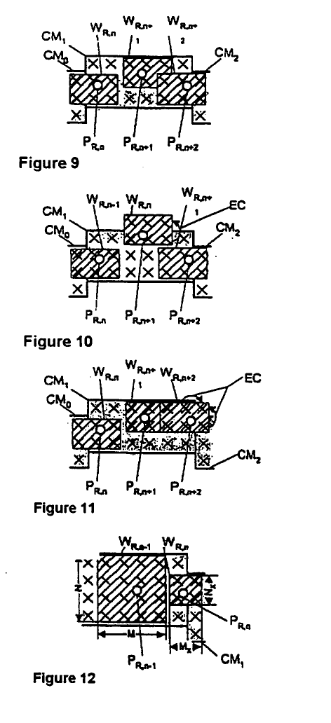

The calculation of the output data is represented in FIG. 9. For an output value P_{R,n} the data of the window W_{R,n} are located in the cache memory and can be used for calculation. Likewise calculation takes place for the output values P_{Rn+1} and P_{Rn+2} with the windows W_{Rn+1} and W_{Rn+2}.

Data not belonging to the active image should be represented by a standard value. This standard value corresponds to the usual digital background and is often seen as black or white. These data must not be stored in the cache memory, instead a processing control unit can signal that these data contain the standard value.

In the event that data of a window W_{R,n} are not in the cache memory, error concealment takes place in that cache memory and/or output processing recognise that data are missing and respond to this. Various processes are possible for the error concealment. These include edge repetition, diagonal approximation to the mean and processing adaptation.

Several measures can be combined for error concealment.

FIG. 10 illustrates the edge repetition. For the window W_{Rn} three dashed pixels are present not in cache memory. The vertical adjacent edge values of the cache memory are used for error concealment (EC) instead of this for processing.

Horizontal adjacent pixels can be used to replace a missing pixel.

FIG. 11 illustrates the diagonal approximation to the mean. For the window W_{R,n} a dashed pixel at the transition of two memory areas is not present in cache memory. A replacement is calculated from two or more adjacent pixels for error concealment (EC) instead.

FIG. 12 illustrates the adaptation of the processing. For calculating the output values usually a window of size M*N is used. In FIG. 12 this is the window W_{R,n-1} of size 4*4 for the output value P_{R,n-1}. In case this area is not available in cache memory, processing proceeds with a window of size Mₓ*N_{X}, where Mₓ is less than M and/or Nₓ is less than N. In FIG. 12 this is the window W_{R,n} of size 2*2 for the output value P_{R,n}.

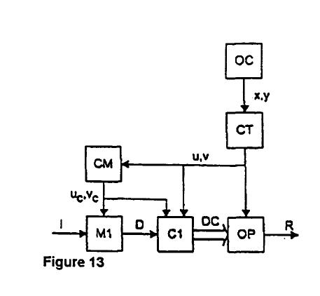

A system for digital processing transformation of coordinates according to the described process is illustrated in FIG. 13. The input image I is stored in the main memory M1. The output control OC generates for each pixel of the output image R its coordinates x, y.

These coordinates are converted by transformation of coordinates CT into transformed coordinates u, v. A control unit for the cache memory CM determines which memory areas, characterised by the coordinates u_{c}, v_{c}, are to be stored in the cache memory. These data D are transferred from the memory M1 to the cache memory C1. By requesting a pixel u, v for processing the cache memory c1 then determines whether the data belong to the active image and are available in the cache memory. According to this check the data or information are fed for error concealment DC to the output processing OP, which calculates the output image R

1. A process for processing signal data, in particular digital signal data processing, whereby a first memory (M1) of comparatively large memory capacity is provided for recording digital data of an original image, whereby the original image comprises at least a first image part and a second image part, whereby the first image part is defined by first initial digital data, and whereby the second image part is structured substantially homogeneously, whereby a second memory (C1) of comparatively lesser memory capacity, in particular a cache memory, is provided, and whereby a control (OC, CT, CM, OP) is provided, which is assigned a control program, whereby for modification of at least one pixel of the original image in another image (R) the control program is equipped such that at least a part of the first initial digital data is transferred from the first memory (M1) to the second memory, and whereby first output digital data, from which the other image (R) is generated, are calculated from the part of the first input digital data stored in the second memory (C1), characterised in that the control program is further outfitted such that to replace first digital data, not stored in the second memory (C1), data are generated after at least one error concealment procedure, and in that information is used precisely to generate the entire second image part in the other image (R).

2. The process as claimed in claim 1, characterised in that the data, which are transferred from the first memory (M1) to the second memory (C1), comprise areas of preset size.

3. The process as claimed in any one of the preceding claims, characterised in that areas, which are transferred from the first memory (M1) to the second memory (C1), join each other horizontally.

4. The process as claimed in claim 3, characterised in that cache controlling of processing units allocates preset addresses according to the horizontal address component to the areas of the input image and determines the vertical position of the areas from the vertical address components.

5. The process as claimed in any one of claims 2 to 4, characterised in that the areas, which are transferred from the first memory to the second memory, join one another vertically.

6. The process as claimed in claim 5, characterised in that cache controlling of processing units allocates preset addresses according to the vertical address components to the areas of the input image and determines the horizontal position of the areas from the horizontal address components.

7. The process as claimed in any one of the preceding claims, characterised in that the position of the horizontal areas is fixed depending on the average value of the horizontal address components, and/or in that the position of the vertical areas is fixed depending on the average value of the vertical address components.

8. The process as claimed in any one of claims 1 to 6, characterised in that the position of the horizontal areas is fixed depending on the minimum or maximum of the horizontal address components, and/or in that the position of the reinforced areas is fixed depending on the minimum or maximum of the vertical address components.

9. The process as claimed in any one of the preceding claims, characterised in that error concealment takes place whereby with access to a data element not found in the second memory another data element found in the second memory is supplied.

10. The process as claimed in any one of claims 1 to 8, characterised in that error concealment takes place in that with access to a data element not found in the second memory and another data element found in the second memory a result of the access is calculated.

11. The process as claimed in any one of claims 1 to 8, characterised in that error concealment takes place in that with access to a data element not found in the second memory the processing unit is informed of the unsuccessful access and the processing unit adapts its processing to the available data.

13. A system for performing the process as claimed in any one of the foregoing claims, whereby a first memory (M1) of comparatively large memory capacity is provided for recording digital data of an original image, whereby the original image comprises at least a first image part and a second image part, whereby the first image part is defined by first initial digital data, and whereby the second image part is structured substantially homogeneously, whereby a second memory (C1) of comparatively lesser memory capacity, in particular a cache memory, is provided, and whereby a control (OC, CT, CM, OP) is provided, which is assigned a control program, whereby for modification of at least one pixel of the original image in another image (R) the control program is equipped such that at least a part of the first initial digital data is transferred from the first memory (M1) to the second memory, and whereby first output digital data, from which the other image (R) is generated, are calculated from the part of the first input digital data stored in the second memory (C1), characterised in that the control program is further outfitted such that to replace first digital data, not stored in the second memory (C1), data are generated after at least one error concealment procedure, and in that information is used precisely to generate the entire second image part in the other image (R).
